(19) United States
(12) Patent Application Publication
(10) Pub. No.: US 2015/0263925 A1
(43) Pub. Date: Sep. 17, 2015

(54) METHOD AND APPARATUS FOR RANKING USERS WITHIN A NETWORK

(71) Applicant: TELEFONAKTIEBOLAGET L M ERICSSON (PUBL), Stockholm (SE)

(72) Inventors: Subramanian Shivashankar, Chennai (IN); Manoj Prasanna Kumar, Chennai (IN); Jawad Mohamed Zahoor, Chennai (IN)

(21) Appl. No.: 14/432,982

(22) PCT Filed: Oct. 5, 2012
(86) PCT No.: PCT/EP2012/069767

§ 371 Date: Apr. 1, 2015

(51) Int. Cl. H04L 12/26; G06N 99/00; G06F 17/30; H04L 12/24; H04L 29/08

(52) U.S. Cl. CPC H04L 43/0876; H04L 41/147; H04L 67/22; G06F 17/3053; H04L 43/04; G06N 99/005

(57) ABSTRACT

A method for ranking users within a network is disclosed. The method includes the steps of generating a ranking measure for each of a plurality of users within the network, monitoring network performance of the plurality of users, and identifying occurrence of conflict between ranking measure and network performance of a user. The method further includes the steps of resolving the conflict by reference to an authority and using information from the resolved conflict to inform subsequent generation of ranking measures. Also disclosed are a computer program product for carrying out a method of ranking users within a network and an apparatus configured to rank users within a network.

### TECHNICAL FIELD

The present invention relates to a method and an apparatus for ranking users within a network. The invention also relates to a computer program product configured to carry out a method for ranking users within a network.

### BACKGROUND

Communication networks are widely used across many industries and sections of society. Such networks may include, for example, telecommunications networks, social media networks, office networks, academia networks and community networks. The use of communication networks is growing, with continual expansion of customer bases driving business growth in this sector.

With the rapid growth of communication networks, the extraction of business intelligence from such networks has become an increasingly important task. Telecommunications networks, for example, may be vast, encompassing many hundreds of thousands of users, or nodes. The ability to identify users within the network matching a particular profile can thus be a great asset in the business management of the network. The particular user profile to be identified may vary according to the purpose for which users are to be identified. For example, on launching an advertising campaign for a new range of services, it may be desirable to identify those users who represent the best potential targets for the advertising campaign. The network operator budget for that particular campaign may be most effectively used by targeting the advertising resources towards those users who are most likely to respond to the campaign in a positive manner that enhances overall network performance. The best potential targets may be those users judged most likely to adopt the new services, or may for example be those users judged to be most influential within the network.

In other examples, an operator may be looking to identify those users meriting special attention including value added services, flexible charging or other advantages. A network operator may look to reward those users who have been most loyal to the network, or who spend the most money within the network. Alternatively, the network operator may look to create positive perception of the network. In this situation, it may again be desirable to identify those users judged to be the most influential within the network; users who, by virtue of their network profiles, may be capable of initiating a viral effect within the network leading to increased service uptake and operator profit.

Indications of user influence within a network can vary according to different network types and definitions of what constitutes an influential user. There exist a wide range of measures to judge the influence of a user within a network. Loyalty or length of time with a network may be one measure of influence. Another measure may be the number of advanced or additional network services adopted by a user. Another frequently used measure of influence is the level of interconnectedness of a user, including user position with respect to different groups or communities within a network. A user who is connected to several different relatively closed communities for example may act as a link between such communities, and thus may occupy a position deemed influential within the network. It will be appreciated that in any particular case, assessing influence of a user within a network is likely to involve a combination of such measures, all of which may impact upon the overall influence exerted by the user on the network. The various measures may take on greater or lesser importance depending upon the particular case in question.

The identification of particular groups of network users is thus an important task in the management of communication networks. To date, development work has focussed on the identification of groups of users judged to be influential, and a common method for performing such identification is the machine learning technique known as supervised learning. According to the supervised learning technique, a subset of data, known as training data, is used to enable a machine to infer a function or classifier for analysing the data. The training data consists of a series of input objects each of which is labelled with an associated output. By analysing the training data the machine infers a function allowing it to correctly predict an output value for any valid input object. In the case of identification of influential users within a communication network, the training data consists of a subset of users and an assessment as to whether or not such users are judged to be influential. This training data is used to train the machine to identify other influential users from within the network.

Under certain circumstances, supervised learning can be a highly effective machine learning technique. However, the method suffers from several drawbacks, particularly when considering the assessment of telecommunications network data. The accuracy of a supervised learning classifier is critically dependant on the quality of the training data. This includes the quantity of training data points available, the quality of data sampling used to assemble the training data and the quality of the labelling of the data with the necessary outputs. For example, if insufficient training data is available, or if the sample space used to build the training data is not sufficiently rich and diverse, the training data may be insufficient to enable development of an accurate prediction model. Similarly, if the quality of the training data labelling is variable, the training data set may be very “noisy”, again impeding development of an accurate prediction model. When considering telecommunications networks, the problem of training data is particularly pertinent as the sheer scale of such networks can prohibit generation of a quality training data set. Telecommunications networks may be of the order of millions of nodes, with no previously available training data and often with no fixed definition as to the labelling criteria. For example, as discussed above, if influence is the labelling criteria, the definition of an influential user may be very variable according to the particular domain or circumstance under consideration. In such situations, it is necessary to employ human operators to label a certain critical set of data points and so permit the development of a prediction model. However, even when using human operators, the training data set may be very noisy as a consequence of variability in human judgement or owing to poor quality of sampling.

A further disadvantage of supervised learning is its relative inflexibility. Existing approaches tend to use a static function that may be unsuited to the highly diverse and heterogeneous nature of telecommunications networks. Such networks may enable multiple link types between users and may generate operator requirements which are more complex and specific than can be realised with a static function. In-degree centrality for example, may be of very limited use if the network operator is seeking to launch a campaign for a closed user group. This inflexibility is also a handicap when considering the evolution of both the network and the operator requirements over time. Telecommunications network operators tend to introduce new services frequently, feeding the constant evolution of the network. The new services may be combinations of existing services or may be totally unrelated to existing services. In either case, this network evolution cannot be adequately captured in the training data labelled before the new services were introduced. The prediction model thus becomes rapidly out of date and may be unable to predict well for situations concerning the newly introduced services. In addition to the evolution of the network, operator requirements may also evolve and a prediction model based on an original set of training data may be unable to meet these changing requirements. For example, a prediction model set up to classify users as influential or not may fail when the operator requirement changes to request only the top X influential users. In a circumstance where budget or other constraints impose additional restrictions on the users to be identified, the established prediction model may be unable to service the request.

### SUMMARY

It is an aim of the present invention to provide a method, apparatus and computer program product which obviate or reduce at least one or more of the disadvantages mentioned above.

According to a first aspect of the present invention, there is provided a method for ranking users within a network. The method comprises generating a ranking measure for each of a plurality of users within the network and monitoring network performance of the plurality of users. The method further comprises identifying occurrence of conflict between ranking measure and network performance of a user, resolving the conflict by reference to an authority and using information from the resolved conflict to inform subsequent generation of ranking measures.

The present invention thus incorporates feedback from actual monitored network performance to inform and improve upon the generation of a ranking measure for a network user. Use of information from a resolved conflict to inform subsequent generation of ranking measures in effect creates a feedback loop, allowing information gleaned from monitored network performance to be fed back into the generation of ranking measures. Embodiments of the invention are thus self-training, incorporating feedback to improve over time. In addition, the present invention incorporates reference to an authority in resolving conflict between a ranking measure and network performance of a user. In this manner, the invention allows the authority to guide the evolution of the generation of ranking measures. The feedback process of using information from a resolved conflict to inform subsequent generation of ranking measures renders the method of the present invention both adaptive and robust.

For the purposes of the present specification, an “authority” may be any person, group of persons, organisation or other legal or natural entity having the power to issue a ruling on a conflict between ranking and performance of a user within a network. For example, an authority may be a network operator, or a human operator or expert or group of such people empowered by the network operator to be the ultimate arbiter of conflict between ranking measure and network performance. In some examples, the authority may be the entity requiring the ranking of users, and may thus guide evolution of the method according to the underlying requirements.

Also for the purposes of the present specification, a “measure” may be any unit of measurement able to indicate a relative judgement according to a ranking scale. Examples of a measure may therefore include a numerical score, a percentage or a grade.

According to embodiments of the invention, users may be ranked according to any selected criterion, which criterion may for example be generated by a network operator. The criterion may for example be a relatively high level criterion and may be of a general nature or may be specific to a particular situation or set of circumstances.

According to an embodiment of the invention, the method may comprise monitoring network performance of each of the plurality of users.

According to another embodiment of the invention, the subsequent generation of ranking measures may comprise generation of ranking measures for the claimed plurality of users or the subsequent generation of ranking measures may comprise generation of ranking measures for a new plurality of users. According to embodiments of the invention, the subsequent generation of ranking measures may comprise generation of ranking measures both for the claimed plurality of users and for a new plurality of users.

Monitoring network performance of the plurality of users may comprise generating a network performance measure for each of the plurality of users. In this manner, a quantitative evaluation of a user's network performance may be established, facilitating easy comparison with the ranking measure in order to identify occurrences of conflict between user ranking and user network performance.

According to some embodiments of the invention, the ranking measure and the network performance measure may for example comprise numerical scores between 0 and 1.

The network performance measure may comprise a measure of the evolution of the network performance of the user over time. This may for example be captured as a change or rate of change of a network performance indicator. In this manner, embodiments of the invention may capture within the feedback loop the evolution of a user's network performance. Generation of ranking measures is thus refined not just according to a snapshot of network performance at an instant in time but according to a progression of network performance over a time frame. This allows distinction not only between high and low performers within a network but also identification of dynamically improving performers.

Identifying occurrence of a conflict between ranking measure and network performance of a user may comprise identifying a pair of users exhibiting a conflict between their respective ranking and network performance measures. Embodiments of the invention may thus draw in data from across the network; rather than comparing only network performance and ranking of a single user, each user's relation to others within the network may also be considered.

According to embodiments of the invention, the individual users of the pair may be indentified from different and diverse regions of the network, allowing for provision of a maximum of information for use in informing subsequent generation of ranking measures. According to further embodiments, each user of a subsequent pair may be drawn from a different region of the network than the members of the previous pair, again maximising the information provided by the pair. This drawing of diverse users may for example be achieved by diverse random sampling.

According to embodiments of the invention, a conflict between respective ranking and performance measures of a pair may comprise a higher ranking measure for a first user than for a second user, combined with a lower network performance measure for the first user than for the second user.

Resolving the conflict by reference to an authority may comprise referring to an authority for a ruling on which of the two users in the pair should have the higher ranking measure. In this manner, embodiments of the invention may increase the ease with which the authority may resolve a conflict, a relative ruling between two users often being easier to provide than an absolute ruling on each user according to a particular standard.

Resolving the conflict by reference to an authority may comprise checking whether or not a similar conflict has already been resolved by the authority and; if a similar conflict has not already been resolved by the authority, making a direct reference to the authority for a ruling on ranking measure of the conflict; or if a similar conflict has already been resolved by the authority, making indirect reference to the authority by adopting the ruling of the authority provided for the earlier similar conflict.

For the purposes of the present specification, a direct reference to the authority may be understood to mean the requesting of a ruling from the authority. An indirect reference to the authority may be understood to mean referring back to previous rulings provided by the authority, thus incorporating the input from the authority via these previous rulings, as opposed to via a new ruling. Embodiments of the invention may thus make efficient use of authority resources, minimising intervention required by the authority by using where possible the results of previous rulings and applying them to new conflict situations.

Similarity with an earlier conflict may for example be established by calculating similarity of each member of the pair with each member of previous pairs. Similarity may be measured according to similarity in network properties of users, or for example according to similarity of user attributes. A similarity score between users may be calculated and similarity score over a threshold value may be considered to denote similar users. A pair in which each of the users is similar to one of the users in a previous pair may be considered to be similar to the previous pair.

Generating a ranking measure may comprise applying a ranking parameter to at least one attribute of a user.

According to embodiments of the invention, the ranking parameter may for example comprise a ranking vector, which may be applied to an input vector containing user attributes. Application of the ranking vector to a user attribute vector may comprise performing a vector dot product operation between the ranking vector and the user attribute vector.

Using information from the resolved conflict to inform subsequent generation of ranking measures may comprise updating the ranking parameter according to information from the resolved conflict.

Updating the ranking parameter may comprise updating the ranking parameter such that the updated parameter generates a ranking measure in accordance with the resolved conflict.

According to embodiments of the invention, updating the ranking parameter may comprise updating the ranking parameter such that when applied to the conflict pair, the updated ranking parameter generates relative ranking measures for the two users in accordance with the authority ruling.

According to embodiments of the invention, the method may further comprise: sampling pairs of users from the network, presenting each pair to the authority for a ruling on relative ranking of each member of a pair with respect to the other member of the pair; and receiving the rulings from the authority. Embodiments of the method may further comprise associating each ruling with its respective pair of users as a training pair; determining a value for a ranking parameter in accordance with the training pairs; and using the ranking parameter in generating the ranking measure for each of the plurality of users within the network. In this manner, embodiments of the invention may enable initial tuning of the ranking process according to authority requirements.

Determining a value for a ranking parameter may comprise iteratively testing potential values of the ranking parameter against the training pairs and selecting that value of ranking parameter which minimises error. Testing potential values of the ranking parameter against the training pairs may comprise applying a potential value of the ranking parameter to each member of the pair and comparing the relative ranking measures obtained with the associated ruling from the authority.

According to embodiments of the invention, the iterative testing process may be performed according to the following objective function:

$$min \frac{1}{\vert P \vert} ( {Σ}_{( a , {y}_{a} ) , ( b , {y}_{b} ) ε P} HingeLoss ( ( a - b ) , sign ( {y}_{a} - {y}_{b} ) , w ) )$$

where a and b are users of a training pair, yₐ and y_{b} denote the ranking measures of the users a and b, P denotes the set of training pairs and w is the ranking parameter.

According to embodiments of the invention, a success counter may be associated with each potential value of the ranking parameter, and the success counter may be incremented each time the potential ranking parameter produces a correct result for a training pair. According to embodiments of the invention, an average of the potential values for the ranking parameter, weighted according to the associated success counters, may be taken. The weighted average value may be used as the ranking parameter for generation of ranking measures.

According to an embodiment, the network may comprise a communications network. The network may comprise a telecommunications network, or may comprise a social network. The social network may be any kind of social network and may for example comprise a web based social networking service, platform or site.

According to another aspect of the present invention, there is provided a computer program product configured, when run on a computer, to carry out the method of the first aspect of the present invention. The computer program product may be stored on a computer-readable medium, or it could, for example, be in the form of a signal such as a downloadable data signal provided from an Internet website, or it could be in any other form.

According to another aspect of the present invention, there is provided an apparatus for ranking users within a network. Embodiments of the apparatus may comprise: a ranking unit configured to generate a ranking measure for each of a plurality of users within a network, and a monitoring unit configured to monitor network performance of the plurality of users. The apparatus may further comprise a feedback unit configured to: (i) identify occurrence of conflict between ranking measure and network performance of a user; (ii) refer the conflict to an authority for resolution; and (iii) feed information from the resolved conflict back to the ranking unit. The ranking unit may be further configured to incorporate information received from the feedback unit in the generation of subsequent ranking measures.

The monitoring unit may be configured to generate a network performance measure for each of the plurality of users. The network performance measure may comprise a measure of the evolution of the network performance of the user over time.

The feedback unit may be configured to identify occurrence of conflict between ranking measure and network performance of a user by identifying a pair of users exhibiting a conflict between their respective ranking and network performance measures.

According to an embodiment of the invention, on identifying a conflict between ranking measure and network performance of a user, the feedback unit may be further configured to check whether or not a similar conflict has already been resolved by the authority, and; if a similar conflict has not already been resolved by the authority, to make direct reference to the authority for a ruling on ranking measure of the conflict; or if a similar conflict has already been resolved by the authority, to make indirect reference to the authority by adopting the ruling of the authority provided for the earlier similar conflict.

According to embodiments of the invention, the apparatus may further comprise a learning unit which may be configured to: (i) sample pairs of users from the network; (ii) present each pair to the authority for a ruling on relative ranking of each member of a pair with respect to the other member of the pair; and (iii) receive the rulings from the authority. The learning unit may be further configured to: (iv) associate each ruling with its respective pair of users as a training pair; and (v) send the training pairs to the ranking unit. The ranking unit may be further configured to determine a value for a ranking parameter in accordance with the training pairs and to use the ranking parameter in generating the ranking measure for each of the plurality of users within the network.

According to embodiments of the invention, on determining that a similar conflict has not already been resolved by the authority, the feedback unit may be configured to refer the conflict to the authority via the learning unit. The learning unit may be configured to send information on the resolved conflict to the ranking unit. In this manner, the feedback unit may feed back to the ranking unit via the active learning unit.

According to embodiments of the invention, the ranking unit may be configured to generate a ranking measure by applying a ranking parameter to at least one attribute of a user. On receiving information from the resolved conflict, the ranking unit may be configured to update the ranking parameter according to the information.

According to an embodiment, the network may comprise a communications network. The network may comprise a telecommunications network, or may comprise a social network. The social network may be any kind of social network and may for example comprise a web based social networking service, platform or site.

According to another aspect of the present invention, there is provided a method of selecting a group of users within a network, comprising: defining a size of the group as a number x of users to be contained in the group; ranking users within the network; and identifying the top x ranked users as members of the group. The users may be ranked according to a criterion which may be defined according to the purpose of the group. Ranking users within the network may be performed according to the method of the first aspect of the present invention.

The information provided by the method, computer program product and apparatus of the present invention may be used by a network operator in management of the network, and/or may be provided to third parties, for example for the purpose of targeted advertising by the third parties. Thus the information provided may thus offer an additional revenue stream for the network operator.

### BRIEF DESCRIPTION OF THE DRAWINGS

For a better understanding of the present invention, and to show more clearly how it may be carried into effect, reference will now be made, by way of example, to the following drawings in which:

FIG. 1 is a flow chart illustrating steps in a method for ranking users within a network;

FIG. 2 is a flow chart illustrating steps in another embodiment of method for ranking users within a network;

FIG. 3 shows an apparatus for ranking users within a network; and

FIG. 4 shows another embodiment of apparatus for ranking users within a network.

### DETAILED DESCRIPTION

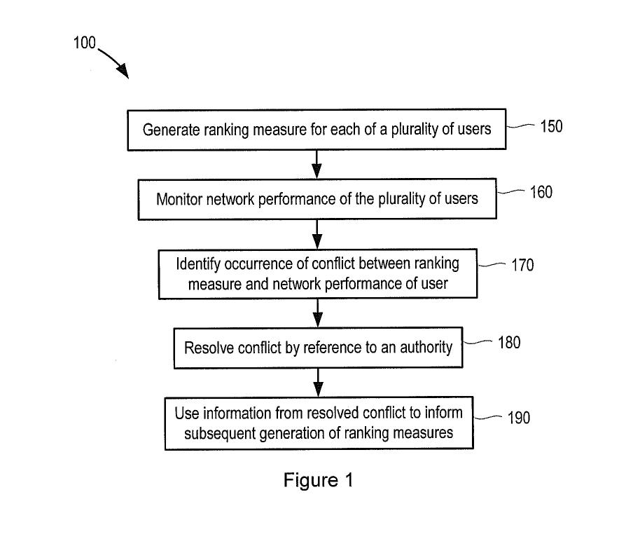

FIG. 1 illustrates steps in a method 100 for ranking users within a network in accordance with an embodiment of the present invention. The network may be a communication network and in one embodiment of the invention the network may for example be a telecommunications network.

With reference to FIG. 1, a first step 150 of the method 100 comprises generating a ranking measure for each of a plurality of users within a network. Once the ranking measures have been generated, the network performance of the plurality of users is monitored in step 160. The method then proceeds at step 170 to identify occurrence of conflict between the ranking measure generated for a user and the network performance of the user. At step 180, the method resolves the identified conflict by reference to an authority. Finally, at step 190, the method uses information from the resolved conflict to inform subsequent generation of ranking measures.

As noted above, existing methods of identifying particular groups of users within a network experience problems with accurate generation of a classification model, and are also unable to adapt to changing operator requirements or to developments within the network over time. This is particularly problematic in telecommunications networks, which tend to be highly heterogeneous and fast evolving. The present inventors have identified that a highly responsive method may be provided by ranking users within a network, as opposed to merely identifying particular groups. Such ranking information is highly adaptable to individual operator requirements, allowing the identification of particular groups of users as well as permitting limitation of the groups by number of users. The present inventors have also discovered that by consulting information that is not intrinsic to the user, and by incorporating this information into the generation of ranking measures, a highly robust and responsive method may be provided. The method of the present invention feeds information concerning user network performance back into the generation of ranking measures, allowing this information to inform the generation of subsequent ranking measures. This feedback loop acts as a check, measuring predicted ranking against actual network performance parameters, allowing refinement of the model generating the ranking measures. In this manner, the present invention does not merely build a predictive model based on known user attributes, but continually refines and updates a predictive model based on a measured indication of success of the model. While previous efforts have focussed on improving the selection of training data for predictive models, the present invention continually improves the model itself, allowing the model to evolve and adapt to changes in operator requirements and in the network itself.

According to an embodiment of the present invention, ranking measures may be generated at step 150 by applying a ranking parameter to a vector of user attributes. The ranking parameter may itself be a vector and the application of the ranking parameter may comprise performing a vector dot product of the user attribute vector and the ranking vector. This dot product operation results in a scalar value which may then become the ranking measure for the user under consideration. Alternatively, further processing may be conducted on the scalar value to arrive at the ranking measure. The ranking measure in this example may be a score of between 0 and 1, or may take other values depending upon the values of the individual components of the ranking vector. The component values of the ranking vector may be determined in advance according to a learning process which is discussed in further detail below. Alternatively, the ranking vector may be given arbitrary values in an initial state and then evolved and refined via feedback information.

Ranking of the plurality of users may be conducted according to any criterion as specified by a network operator. The criterion may be relatively simple and equate to a measurable user attribute, such as additional services used within the network, money spent on network services or length of time with the network. In these circumstances a comparatively simple ranking vector can identify the relevant user attribute and rank users according to that attribute. Alternatively, the criterion according to which users are to be ranked may be more complex and of a higher level, for example likely receptiveness to a new advertising campaign, or influence within the network. Other examples of high level criteria include the top X influential users with respect to a particular service or in a particular location, or the top X influential users with respect to a proposed future service which is a specific combination of existing services. These high level criteria can be broken down into combinations of more easily assessed user attributes. For example, in assessing receptiveness to a new campaign, a user's loyalty to the network, historical use of additional services and spending habits within the network may all be of relevance. The relative importance of each of these factors may be assessed and reflected in the different values attributed to the components of the ranking vector. By placing varying levels of importance on different user attributes, the ranking vector can provide a ranking score for a user reflective of the higher level criterion. Tuning of the ranking vector to accurately reflect the chosen criterion can be achieved through authority reference and feedback and may also be achieved through the initial learning process referenced above. Both these processes are discussed in further detail below.

Once ranking measures have been assigned to each of a plurality of users, the method proceeds at step 160 to monitor the network performance of the plurality of users. This may involve monitoring a set of network growth and/or node ego network growth parameters. The choice of particular performance measures to be monitored may depend upon the ranking situation under consideration, as discussed in further detail below. Network growth parameters may provide a general view of how a user is performing with respect to general network growth. Node ego network growth parameters may provide an indication of how a particular user is developing with respect to other users, and how this is impacting overall network performance. For example if the ego network of a user (the network of users to whom the user is connected) is increasing or becoming more interconnected then this may indicate that the user is contributing to improved network performance.

Monitoring of network performance of the plurality of users enables the method, at step 170 to identify occurrence of conflict between the ranking measure and network performance of a user. For example, conflict might occur in a case where a high ranking measure has been applied to a user but the monitoring of network performance indicates that it is not performing as well as its ranking measure would suggest. At step 180, this conflict is resolved by reference to an authority. An authority may for example be the entity that generated the ranking requirement, which may for example be the network operator. In other examples, the authority may a human operator or group of operators able to assess the identified conflict and provide a definitive ruling as to the appropriate ranking measure.

Information gleaned from the resolved conflict is then fed back, at step 190, to inform the subsequent generation of ranking measures. This process of informing may in some embodiments comprise updating the ranking vector in accordance with the resolved conflict, for example to ensure that the updated ranking vector generates a ranking measure that is in accordance with the resolved conflict. By continually referencing the authority, the method of the present invention allows the authority to refine the process by which ranking measures are generated, thus continually improving the accuracy of the ranking measures generated. This reference also allows the method to adapt to new circumstances or changing requirements without completely restarting the process. The ranking process is able through the feedback to evolve over time to accommodate new requirements of changing situations.

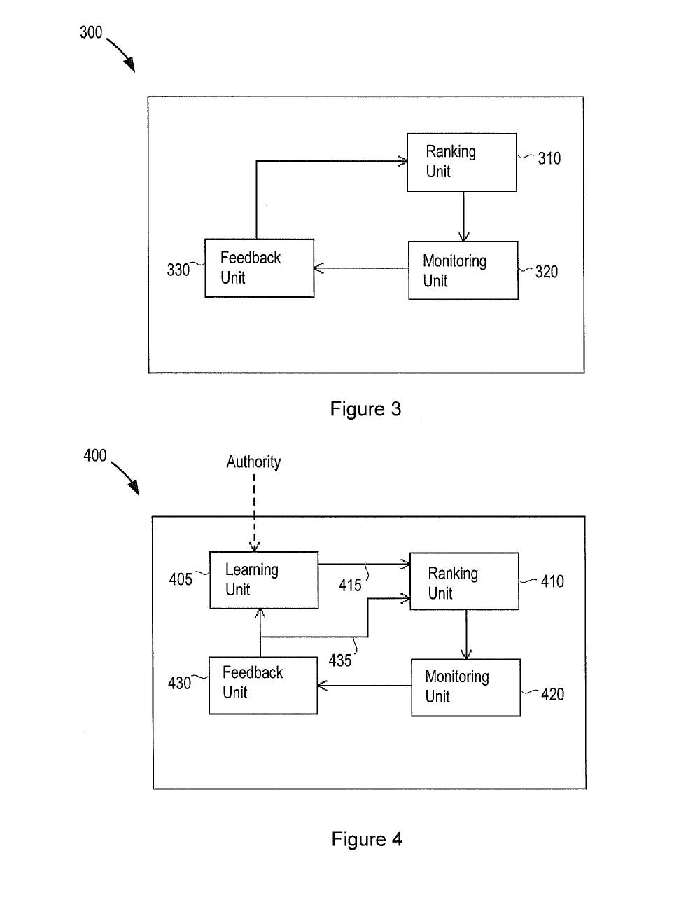

The method 100 of FIG. 1 may be realised by a computer program which may cause a system, processor or apparatus to execute the steps of the method 100. FIG. 3 illustrates functional units of an apparatus 300 which may execute the steps of the method 100, for example according to computer readable instructions received from a computer program. The apparatus 300 may for example comprise a processor, a system node or any other suitable apparatus.

With reference to FIG. 3, the apparatus 300 comprises a ranking unit 310, a monitoring unit 320 and a feedback unit 330. It will be understood that the units of the apparatus are functional units, and may be realised in any appropriate combination of hardware and/or software.

According to an embodiment of the invention, the ranking unit 310, monitoring unit 320 and feedback unit 330 may be configured to carry out the steps of the method 100 substantially as described above. The ranking unit may be configured to generate ranking measures for each of the plurality of users. The monitoring unit 320 may be configured to monitor network performance of the plurality of users. The feedback unit 330 may be configured to identity occurrence of conflict between ranking measure and network performance of a user, to resolve the conflict by reference to an authority, and to feed information from the resolved conflict back to the ranking unit. The ranking unit 310 may further be configured to incorporate information received from the feedback unit in the generation of subsequent ranking measures.

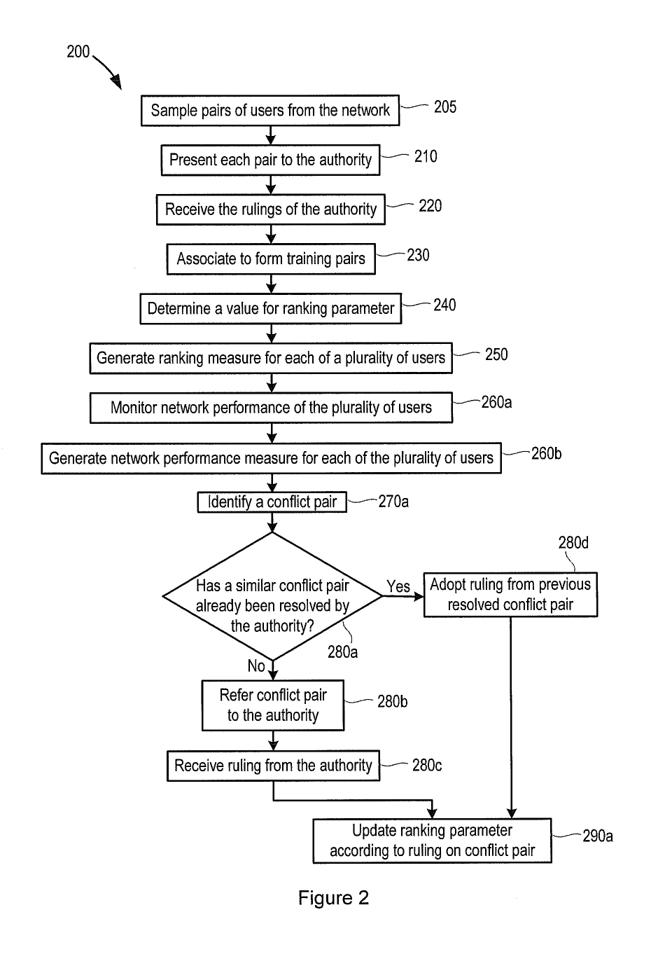

FIG. 2 illustrates steps in a method 200 for ranking users within a network in accordance with another embodiment of the present invention. The method 200 illustrates how the steps of the method 100 may be further subdivided in order to realise the functionality described above. The method 200 also comprises additional steps which reflect the learning process referred to above and which, according to an embodiment of the invention, may be performed before the method steps of the first embodiment 100.

The learning process of the embodiment illustrated in FIG. 2 uses authority involvement to define a set of training data specific to a particular situation or query. This training data allows for generation of an initial ranking parameter that reflects the desired ranking criterion. As discussed above, this may be a simple or more complex criterion, but by incorporating authority involvement in the generation of training data, the initial value of the ranking vector may more accurately reflect the requirements of the authority. In this manner, the feedback loop of the present invention may function merely to correct and refine the parameter, rather than developing it form an arbitrary starting point. The learning process uses pairwise comparison to generate labelled examples forming a training data set.

The method of FIG. 2 is described with respect to a query q in the form of a requirement to rank users in a network according to a particular criterion. With reference to FIG. 2, in a first step 205, the method samples pairs of users from the network. The method seeks to identify pairs for the training data set that convey a maximum of information in order to generate the most accurate ranking parameter from this data set. Pairs formed of two users having very similar attributes are unlikely to convey a large amount of information. Similarly, a new training pair that is similar to an existing training pair is unlikely to convey a significant amount of new information to inform development of the ranking parameter. It may therefore be desirable to select each member of a pair from a different region of the network or class of users, and to select each training pair to be different in some way from the preceding training pair. According to one embodiment, diverse random sampling may be employed to select appropriate pairs. An example procedure for sampling pairs of users is described below.

A network under consideration may be considered as being formed from nodes, each node having the capacity to link to other nodes via edges. In a telecommunications network, for example, each node represents a user, and the edges linking the nodes are formed by contacts made between users, for example in the form of calls, messages etc. Each node within the network comprises a series of node attributes which include usage data and may for example include customer relations management (CRM) information, if this is available. A clustering algorithm is used to identify K clusters within the network. The clustering algorithm may for example be a graph cuts algorithm, or may be any other suitable clustering algorithm. The number K of clusters to be identified may be a predefined number or may be chosen to be the number having the least residual value or loss. Each of the identified clusters is labelled C₁ to C_{K}. A fist cluster Cᵢ, is then selected according to a sampling strategy, where i ∈ (1 to K). The sampling strategy may be uniform random sampling or any other desired sampling strategy. A second cluster Cⱼ is then selected, where j ∈ (1 to K) and j ≠ i, wherein Cⱼ has a maximum distance from Cᵢ. A node is then selected from each of Cᵢ and Cⱼ. The nodes may be selected in a uniform random fashion or according to any other sampling strategy. The selected nodes form a pair, and the later steps of the process may be repeated to select other pairs, each from clusters remote from each other and from those that have already been sampled. The number of pairs sampled to form a training data set may vary according to the size and type of the network, and the complexity of the criterion according to which users are to be ranked. In one example concerning a telecommunications network, a number in the region of 500 pairs may be sampled to form a training data set.

After sampling pairs of users from the network, the method then proceeds, at step 210, to present each pair to the authority for a ruling. As discussed above, the authority may be the entity that operates the network, for example via a group of individual operators briefed as to the requirements of the network operator. The authority is requested to provide a ruling as to which member of each pair has the higher rank. For example, in a sample pair comprising user A and user B, the query presented to the authority is whether A is higher ranked than B, or B is higher ranked than A. In a case where the ranking is to be conducted according to influence, the query would therefore be whether A is more influential than B, or B is more influential than A. In a case concerning receptiveness to an advertising campaign, the query would be whether A is likely to be more receptive than B, or B is likely to be more receptive than A. This pairwise comparison is far simpler for an operator to perform than for example assigning a label of high or low rank, influential or non influential, to an individual node. The rulings given by the authority provide the labels to form a training data set that is then used to develop the ranking parameter. In this manner the authority governs the development of the ranking parameter, guiding selection of appropriate components for the ranking parameter to rank users according to the criterion selected by the authority.

Rulings are received from the authority at step 220 of the method and at step 230, each ruling is associated with the pair that is the subject of the ruling to form a set of training pairs. Each training pair thus includes an input of details of the two users and an output of a ruling as to which of the pair is higher ranked.

The method then proceeds to step 240, in which the training data set is used to determine a ranking parameter. According to an embodiment of the method, the following objective function may be used:

$$min \frac{1}{\vert P \vert} ( {Σ}_{( a , {y}_{a} ) , ( b , {y}_{b} ) ε P} HingeLoss ( ( a - b ) , sign ( {y}_{a} - {y}_{b} ) , w ) )$$

where: P is the set of training pairs, a and b denote users in the network, yₐ and y_{b} are their ranking scores, w is the ranking parameter and HingeLoss refers to the Hinge loss function. yₐ and y_{b} are numerical scores and yₐ is assumed to be 1 with y_{b} assumed to be 0 for the case where a is ranked higher than b.

This objective function may be implemented in the following iterative procedure.

Following sampling and receipt of labels from the authority, training instances are constructed in the form: (a, b, val) where a and b are the users of the sampled pair and val is an indicator of which of the pair was more highly ranked by the authority. Thus a training instance (a, b, 1) is created where the authority indicated a to be higher ranked than b, and a training instance (a, b, −1) is created where the authority indicated b to be higher ranked than a. These training instances are input to the iterative algorithm, with the output being a ranking parameter w. This ranking parameter is a vector w, which may be thought of as a weighting vector, as the components of the vector indicate the relative weight that is to be attributed to each component of the user attribute vector in determining the ranking score of the user. The iterative procedure is as follows:

Initialise: i=0
cᵢ=0
w=w₀

n_{q}=1/|S_{q}|

where: c is a success counter, w₀ is an initial value for the ranking vector, q is a reference for the current query represented by the set S_{q} of training instances. The training instances S_{q} are constructed form the set of labelled training pairs P.

For t=0, . . . , T:

For each training instance (a, b, Val) ∈ S_{q}:

If (Val ==1)

If Score (a, wᵢ) < Score (b, wᵢ) then
Update wᵢ +1 = wᵢ + n_{q}

Else

cᵢ = cᵢ +1

If(Val==−1)

If Score (b, wᵢ) < Score(a, wᵢ) then
Update wi+1 = wi + n_{q}

Else

cᵢ = cᵢ +1

Output weights and their success count (wᵢ, cᵢ,) pairs.

According to this iterative procedure, an initialized trial ranking vector w₀ is applied to each of the users of a first training pair. The application of the ranking vector comprises performing a vector dot product of the ranking vector with the attribute vector of the user in question. The result is a scalar representing the user's ranking score or measure. If the trial ranking vector produces ranking scores for the pair of users that are not in accordance with the authority ruling (a>b or b>a), then the trial ranking vector is incremented with the query balancing factor n_{q}. If on the other hand the trial ranking vector does produce ranking scores in accordance with the authority ruling, the success counter cᵢ is incremented. Once all the training pairs have been input to the procedure, the result is a series of pairs of trial ranking vectors wᵢ with their associated success counts cᵢ.

A single ranking vector for use in subsequent method steps is then obtained by taking an average of the trial ranking vectors, weighted according to the associated success counters:

$$Average \text{:} \frac{1}{Z} {\sum }_{i} {c}_{i} {w}_{i} where Z = {\sum }_{i} {c}_{i}$$

In this manner, the method allows for a semi supervised learning technique, bootstrapped with training examples given by an authority. A ranking model, in the form of a ranking parameter, is learned according to a set of training data provided by an authority, the ranking model is improved over time through the incorporation of feedback.

In the event of a new query accompanied by a new set of training data, the above iterative procedure may be followed to recompute success counters according to the new training data set, with a weighted average providing the ranking parameter for use with the new query.

Having established the ranking parameter for use in the current query q, the method proceeds to step 250, in which ranking measures are generated for a plurality of users within the network. As described above, these ranking measures may take the form of scores generated by performing a vector dot product of a user attribute vector with the ranking vector. The scores obtained from the vector dot product may be used directly as the ranking measure or may be further processed, for example to obtain a percentage or a grading.

Network performance of the plurality of users is then monitored at step 260a, and a network performance measure for each of the plurality of users is generated at step 260b.

A set of domain specific parameters and network parameters may be monitored as part of the network performance monitoring that enables useful feedback. The network parameters may be monitored using social network analysis or other techniques. Examples of parameters which may be monitored include the following:

Domain Specific Parameters:

Service adaptation: if services taken up by a user are also adopted by neighbours of the user, then that user may be judged to be influential within the network for the uptake of services. This may be an important measure for example if the query is to identify promising targets for an advertising campaign.

Service Adaptation Score (SA)=Σₓ Number of neighbours who adopt service X/(S*N)

Where S is the total number of services, and N is the total number of neighbours of A.

Referrals: if a user successfully refers new users to the network or to any particular service, that referral may be captured via customer relations management (CRM) data. That user may be judged to be influential in introducing new users to the network and thus valuable to the network. This may be an important measure for example if the query is to target users for preferential treatment or value added services.

Referral Score (RS)=Number of customers successfully referred by user A/Total number of successful referrals.

Both these measures can be considered as indications of the measured influence of the user within the network. Influence growth of the user can also be measured by monitoring change of these measures over time. Growth of a particular score S, may be computed as (Sₒ−Sₙ), where Sₒ is the score (captured using any of the domain specific metrics) for a customer at a reference time and Sₙ is the score after n time periods. Similarly rate of change can be captured using Σᵢ(Sₒ−Sᵢ)/n.

Network Parameters:

Centrality: various measures of centrality may be employed, including for example degree centrality, eigen vector centrality, closeness etc. All of these measures provide an indication of the relative importance, or influence of the user within the network. Any or all of these measures may be employed to provide information concerning the network performance of a user. Growth of network centrality may also be measured as (Cₒ−Cₙ), where Cₒ is an initial centrality score for a user at a reference time and Cₙ is the centrality score after n time periods. Similarly rate of change may be captured using Σᵢ(Cₒ−Cᵢ)/n.

Degree centrality may be employed to measure the number and growth of direct connections a user has to other users within the network. Each direct connection represents a neighbour, and as the number of neighbours increases, so does the score of the user.

Eigen vector centrality may also be employed to measure influence growth of users over time. For example, if the number of neighbours of the user's neighbours is increasing linearly over time, then the influence of the user is considered to be growing.

Clustering coefficient: if a user A is present in many closed groups then that user functions as a connecting point for all the closed groups of which they are member. This measure is captured by taking the ratio of number of closed groups A is a member of to the total number of closed groups within the network. Growth and rate of growth of this measure may be captured as described above.

Capturing growth and rate of change of the various domain specific and network parameters enables the identification both of consistently high performing users and of dynamically improving users. Both these types of users may be important to identify, depending upon the particular query under consideration.

The above are just some examples of performance parameters which may be measured and assembled to form a single network performance score of a user. This single network performance score may be calculated as an average of the normalized scores mentioned above and may be augmented by many other rich domain specific and social network analysis metrics.

It will be appreciated that the precise combination of measures assembled to form the network performance score may be varied according the particular query under consideration. It is likely that the network parameters such as centrality and clustering coefficient will always be included, but domain specific parameters for inclusion in the network performance score may be selected according to the query under consideration, possibly by the network operator. In this manner, the network performance score may be tailored to be as accurate a representation as possible of the success of the ranking parameter. By tailoring the network performance score to reflect the aim of the network operator in running the query, accurate feedback as to the success of the ranking model can be provided.

Having generated a network performance measure for each of the plurality of users the method proceeds, at step 270a, to identify a conflict pair. A conflict pair is a pair of users in which the ranking and network performance measures are not in agreement. For example, considering users A and B, these users would be in conflict if A has a higher ranking measure than B but a lower network performance measure. This would indicate that the prediction of the ranking parameter has not matched the reality of network performance for at least one of these two users. An example situation could include a ranking measure for user A of 0.90 and a network performance measure for A of 0.70, while user B has a ranking measure of 0.50 and network performance measure of 0.90. The conflict in ranking measure and network performance measure of A and B can be seen in that A has a lower network performance measure than B but a higher ranking measure than B. If the difference in measures is very small then this difference may be discounted, and pair not considered as a conflict pair. However, if this difference is greater than a threshold value A, then the pair may be considered to be a conflict pair, suitable for raising as a query. The identified conflict pair will be used to tune the ranking parameter and it may therefore be desirable to select pairs that provide the greatest amount of information possible concerning the ranking parameter. A similar sampling technique to that discussed above may therefore be employed, in which each member of each pair is selected to be different to the other member of the pair, and each subsequent pair is selected to be different to the preceding pair. Diverse random sampling is one sampling technique that may be used.

Having identified a conflict pair, the method then proceeds to make either direct or indirect reference to the authority to resolve the conflict. If the conflict pair is not similar to any previous conflict pair, then direct reference is made to the authority by raising a query. However, if the conflict pair is similar to a conflict pair that has already been raised as a query to the authority, then indirect reference is made to the authority by adopting the previous authority ruling for the similar pair, and applying it to the conflict pair in question.

The method first assesses, at step 280a, whether or not the conflict pair is similar to any other conflict pair that has already been resolved by the authority. Similarity is calculated by assessing similarity of each member of the pair with each member of the previous pair. For example, considering pairs (A, B) and (C, D), if A is similar to C and B is similar to D, or A is similar to D and B is similar to C then the two pairs are considered to be similar. Similarity between users may be computed by comparing user attributes (for example usage data), by comparing ego network properties or by comparing any other relevant data. If a similarity score is greater than a threshold value of for example 0.8, then the users may be considered to be similar.

If the conflict pair is found to be similar to a conflict pair that has already been resolved by the authority, then the method adopts, at step 280d, the ruling form the previous, similar conflict pair, and applies it to the existing conflict pair. For example, if in the previous ruling C was ruled by the authority to be higher ranked than D, then that ruling will be adopted for the new pair by indicating that the user similar to C (for example user A) is higher ranked than the user similar to user D (for example user B).

If the conflict pair is not found to be similar to a previous conflict pair already resolved by the authority, then direct reference is made to the authority by raising the conflict pair as a query to the authority at step 280b. At step 280c, the method receives the ruling from the authority in the form of an indication as to which of the two users in the pair should be more highly ranked. According to an embodiment of the invention, details of the conflict pair and the ruling provided by the authority may be stored in a memory for subsequent reference.

By referencing previous rulings of the authority, the method minimises the intervention required by the authority, and only raises a query to the authority in the event of a genuinely different conflict pair that can provide useful new information to inform the ranking parameter.

After resolving the conflict embodied by the conflict pair, either by direct reference to the authority or by indirect reference to the authority via stored details of a ruling on a similar pair, information from the resolved conflict is used to update the ranking parameter, at step 290a of the method.

In order to update the ranking parameter, the resolved conflict pair and ruling are used to construct a further training instance (a, b, val) and a further iteration of the iterative process described above is used to update the ranking parameter being used at the time. If this is the first conflict pair to be resolved, then the ranking parameter in use will be the average ranking parameter calculated following learning with the training data set. If however, this is not the first conflict pair to be resolved, then the average ranking parameter will already have been updated in previous iterations and the current ranking parameter is updated according to the training instance constructed from the latest resolved conflict pair. In this manner, input from the authority is used to refine and update the ranking parameter. This input may assist with increasing accuracy of the ranking model, and/or may enable the ranking model to adapt to take account of changes in the network or in the operator requirements.

Following updating of the ranking parameter, the method returns to step 270a to identify a new conflict pair, and the process of resolving the conflict pair and updating the ranking parameter is repeated. Thus, each iteration of a new conflict pair in effect provides a new training instance to continually refine and update the ranking parameter. With each iteration, the method continues to learn. During this time, the method may continue to generate ranking parameters for the plurality of users, or for a new plurality of users according to the latest version of the ranking parameter, and may continue to monitor network performance. The method of the present invention is thus in continual development, allowing it to be constantly refined and updated.

The method of the present invention may be implemented in hardware, or as software modules running on one or more processors. The method may also be carried out according to the instructions of a computer program, and the present invention also provides a computer readable medium having stored thereon a program for carrying out any of the methods described herein. A computer program embodying the invention may be stored on a computer-readable medium, or it could, for example, be in the form of a signal such as a downloadable data signal provided from an Internet website, or it could be in any other form.

FIG. 4 illustrates functional units of an apparatus 400 which may execute the steps of the method 200, for example according to computer readable instructions received from a computer program. The apparatus 400 may for example comprise a processor, a system node or any other suitable apparatus.

With reference to FIG. 4, the apparatus 400 comprises a learning unit 405, a ranking unit 410, a monitoring unit 420 and a feedback unit 430. The apparatus is configured to receive information from an authority which does not form part of the apparatus. It will be understood that the units of the apparatus are functional units, and may be realised in any appropriate combination of hardware and or software.

According to an embodiment of the invention, the learning unit is configured to perform steps 205 to 230 of the method 200, sampling pairs from the network, presenting each pair to the authority for a ruling on the relative ranking of each member of a pair with respect to the other member of the pair, and receiving the rulings from the authority. On receipt of the rulings, the learning unit 405 is configured to associate each ruling with its respective pair of users as a training pair and to send the training pairs to the ranking unit 410.

The ranking unit 410 is configured to perform steps 240 and 250 of the method 200, determining a value for a ranking parameter from the training pairs received form the learning unit, and generating a ranking measure for each of a plurality of users within the network.

The monitoring unit 420 of apparatus 400 is configured to perform steps 260a and 260b of the method, monitoring network performance of the plurality of users, and generating a network performance measure for each of the plurality of users.

The feedback unit 430 of the apparatus 400 is configured to perform steps 270a, 280a, 280b and 280d of the method 200. The feedback unit 430 is configured to identify occurrence of conflict between ranking measure and network performance of a user by identifying a conflict pair, to refer the conflict to an authority for resolution; and to feed information from the resolved conflict back to the ranking unit 410. On identifying a conflict pair, the feedback unit 430 is configured to check whether or not a similar conflict has already been resolved by the authority. If a similar conflict has not already been resolved by the authority, the feedback unit 430 is configured to make direct reference to the authority for a ruling on ranking measure of the conflict. This direct reference is made via the learning unit 405 which receives the conflict pair from the feedback unit 430 and raises the conflict pair as a query to the authority. If a similar conflict has already been resolved by the authority, the feedback unit 430 is configured to make indirect reference to the authority by adopting the ruling of the authority provided for the earlier similar conflict.

The feedback unit 430 is further configured to send information from the resolved conflict pair to the ranking unit 410. The ranking unit 410 may receive the information directly from the feedback unit 430, if a ruling from a previous conflict pair has been adopted by the feedback unit 430 (link 435 in FIG. 4), or indirectly via the learning unit 405, if the conflict pair has been raised as a query to the authority (link 415 in FIG. 4). If direct reference has been made to the authority via the learning unit 405, the learning unit is configured to place details of the conflict pair and of the ruling received from the authority in a memory accessible to the feedback unit 430. Details of previous conflict pairs resolved by the authority are thus available for the feedback unit 430 to consult in assessing similarity between conflict pairs and adopting previous conflict resolutions.

On receiving information concerning the resolved conflict pair, the ranking unit is configured to perform step 290a of the method, updating the ranking parameter according to the ruling on the conflict pair.

Application of the present invention to an example query for a telecommunications network is now described. A situation may be envisaged in which a network operator of a telecommunications network is launching a new advertising campaign. The budget for the new campaign may be most effectively employed by directing targeted advertising to those users most likely to be receptive to the campaign. In this manner, a maximum return may be expected for the outlay of the campaign budget.

In this situation, the learning unit 405 of an embodiment of the invention may be configured to select diverse pairs for development of a training data set. The clustering of the network users allowing selection of pairs for training may be conducted according to user attributes. For example, one cluster may contain users having high spending but low network loyalty, with a further cluster containing those users having good network loyalty but lower network spending. By clustering in this manner according to user attributes, the learning unit 405 may select very different users to form a training pair. A highly loyal, low spending user A may be combined with a high spending but non loyal user B. This pair is then submitted, together with many others, for labelling by the authority, which may be the network operator or body briefed by the network operator as to the network operator's requirements. The authority then labels the training pairs, indicating which user of each pair is most likely to be receptive to the new advertising campaign. By selecting such diverse users to firm the training pairs, the learning unit 405 ensures a maximum of information can be extracted from each pair to inform generating of a ranking parameter.

On receiving the labelled training data set form the learning unit 405, the ranking unit 410 may then run the iterative procedure described above to generate a ranking parameter. Based upon the training data provided by the learning unit, the developed ranking parameter will be tuned to rank users according to their likely receptiveness to the new advertising campaign. The monitoring unit 420 monitors network performance of the ranked users and generates a network performance measure, which measure may also be tuned by the authority to best reflect the feedback required. The feedback unit 430 identifies pairs of users exhibiting a conflict between their allocated ranking measure and monitored network performance measure and resolves these conflicts. Resolution may be conducted by referring the conflict pair to the learning unit 405 for raising to the authority, if no similar conflict has already been resolved, or by adopting a previous authority ruling given for a similar conflict pair. Information from each resolved conflict is received by the raking unit 410, allowing the ranking unit to continually update the ranking parameter to make more accurate predictions.

The network operator is provided with a continually updating ranked list indicating likely receptiveness to the new campaign. The operator may decide how many users can be targeted with the campaign budget and select the top X users to be targeted in the advertising campaign. In the case of an ongoing campaign, success of the advertising may be reflected in the feedback provided by the feedback unit 430, allowing the ranking unit to continually improve the predictions made as to which users may be most receptive to the campaign. Thus new users not previously identified may appear in the list of top X users, as the ranking unit makes ever more accurate predictions. Evolution of the network, or of operator requirements, is captured within the feedback loop.

It will be appreciated that several instances of the present invention may be implemented concurrently in a single network. Different queries concerned with short, medium and long term management of the network may be implemented by a single network operator. Information form the different queries may be shared to enhance performance of each individual ranking process.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for ranking users within a network, comprising:
generating a ranking measure for each of a plurality of users within the network;
monitoring network performance of the plurality of users;
identifying occurrence of conflict between ranking measure and network performance of a user;
resolving the conflict by reference to an authority; and
using information from the resolved conflict to inform subsequent generation of ranking measures.

2. The method as claimed in claim 1, wherein monitoring network performance of the plurality of users comprises generating a network performance measure for each of the plurality of users.

3. The method as claimed in claim 2, wherein the network performance measure comprises a measure of the evolution of the network performance of the user over time.

4. The method as claimed in claim 2, wherein identifying occurrence of a conflict between ranking measure and network performance of a user comprises identifying a pair of users exhibiting a conflict between their respective ranking and network performance measures.

5. The method as claimed in claim 4, wherein resolving the conflict by reference to an authority comprises referring to an authority for a ruling on which of the two users in the pair should have the higher ranking measure.

6. The method as claimed in claim 1, wherein resolving the conflict by reference to an authority comprises determining whether or not a similar conflict has already been resolved by the authority; and
based on determining that a similar conflict has not already been resolved by the authority, making a direct reference to the authority for a ruling on ranking measure of the conflict; and
based on determining that a similar conflict has already been resolved by the authority, making indirect reference to the authority by adopting the ruling of the authority provided for the earlier similar conflict.

7. The method as claimed in claim 1, wherein generating a ranking measure comprises applying a ranking parameter to at least one attribute of a user.

8. The method as claimed in claim 7, wherein using information from the resolved conflict to inform subsequent generation of ranking measures comprises updating the ranking parameter according to information from the resolved conflict.

9. The method as claimed in claim 8, wherein updating the ranking parameter comprises updating the ranking parameter such that the updated parameter generates a ranking measure in accordance with the resolved conflict.

10. The method as claimed in claim 8, wherein:
monitoring network performance of the plurality of users comprises generating a network performance measure for each of the plurality of users;
identifying occurrence of a conflict between ranking measure and network performance of a user comprises identifying a pair of users exhibiting a conflict between their respective ranking and network performance measures;
resolving the conflict by reference to an authority comprises referring to an authority for a ruling on which of the two users in the pair should have the higher ranking measure; and
updating the ranking parameter comprises updating the ranking parameter such that when applied to the conflict pair, the updated ranking parameter generates relative ranking measures for the two users in accordance with the authority ruling.

11. The method as claimed in claim 1, wherein the method further comprises:
sampling pairs of users from the network;
presenting each pair to the authority for a ruling on relative ranking of each member of a pair with respect to the other member of the pair;
receiving the rulings from the authority;
associating each ruling with its respective pair of users as a training pair;
determining a value for a ranking parameter in accordance with the training pairs; and
using the ranking parameter in generating the ranking measure for each of the plurality of users within the network.

12. The method as claimed in claim 11, wherein determining a value for a ranking parameter comprises iteratively testing potential values of the ranking parameter against the training pairs and selecting that value of ranking parameter which minimises error.

13. A computer program product comprising a non-transitory computer readable medium storing computer readable code which, when run on a computer processor, causes the computer processor to carry out the method of claim 1.

14. An apparatus for ranking users within a network, comprising:
a ranking unit configured to generate a ranking measure for each of a plurality of users within a network;
a monitoring unit configured to monitor network performance of the plurality of users; and
a feedback unit configured to:
i) identify occurrence of conflict between ranking measure and network performance of a user;
ii) refer the conflict to an authority for resolution; and
iii) feed information from the resolved conflict back to the ranking unit,
wherein the ranking unit is further configured to incorporate information received from the feedback unit in the generation of subsequent ranking measures.

15. The apparatus as claimed in claim 14, wherein, on identifying a conflict between ranking measure and network performance of a user, the feedback unit is further configured to determine whether or not a similar conflict has already been resolved by the authority, and;
based on determining that a similar conflict has not already been resolved by the authority, to make direct reference to the authority for a ruling on ranking measure of the conflict; or
based on determining that a similar conflict has already been resolved by the authority, to make indirect reference to the authority by adopting the ruling of the authority provided for the earlier similar conflict.

16. The apparatus as claimed in claim 14, further comprising a learning unit configured to:
i) sample pairs of users from the network;
ii) present each pair to the authority for a ruling on relative ranking of each member of a pair with respect to the other member of the pair;
iii) receive the rulings from the authority;
iv) associate each ruling with its respective pair of users as a training pair; and
v) send the training pairs to the ranking unit;
wherein the ranking unit is further configured to determine a value for a ranking parameter in accordance with the training pairs and to use the ranking parameter in generating the ranking measure for each of the plurality of users within the network.

17. The apparatus as claimed in claim 16,
wherein, on identifying a conflict between ranking measure and network performance of a user, the feedback unit is further configured to determine whether or not a similar conflict has already been resolved by the authority,
based on determining that a similar conflict has not already been resolved by the authority, to make direct reference to the authority for a ruling on ranking measure of the conflict; and
based on determining that a similar conflict has already been resolved by the authority, to make indirect reference to the authority by adopting the ruling of the authority provided for the earlier similar conflict;
wherein, on determining that a similar conflict has not already been resolved by the authority, the feedback unit is configured to refer the conflict to the authority via the learning unit, and
wherein the learning unit is configured to send information on the resolved conflict to the ranking unit.

18. The apparatus as claimed in claim 14, wherein the ranking unit is configured to generate a ranking measure by applying a ranking parameter to at least one attribute of a user and wherein, on receiving information from the resolved conflict, the ranking unit is configured to update the ranking parameter according to the information.
